(19) United States
(12) Patent Application Publication
(10) Pub. No.: US 2026/0356770 A1
(43) Pub. Date: Nov. 12, 2026

(54) FERTILISER COMPOSITION FROM NITRIC ACID METAL SLAG

(71) Applicant: SABIC GLOBAL TECHNOLOGIES B.V., Op Zoom (NL)

(72) Inventors: Mohamed AL-RABHI, Riyadh (SA); Aghaddin MAMEDOV, Riyadh (SA)

(73) Assignee: SABIC AGRI-NUTRIENTS COMPANY, Riyadh (SA)

(21) Appl. No.: 19/129,361

(22) PCT Filed: Nov. 14, 2023
(86) PCT No.: PCT/IB2023/061485

§ 371 Date: May 13, 2025

Related U.S. Application Data
(60) Provisional application No. 63/425,043, filed on Nov. 14, 2022.

(51) Int. Cl. C05B 5/00

(52) U.S. Cl. CPC C05B 5/00

(57) ABSTRACT

Disclosed is a fertilizer containing soluble calcium (Ca), nitrogen (N) present as ammonium and nitrate, and sulfur(S) present as sulfate to provide a quick release fertilizer, with optional silicates to provide a slow release form. The source for production of the fertilizer can be waste products from industrial processes. Methods of making and using the fertilizer are also disclosed.

### CROSS-REFERENCE TO RELATED APPLICATIONS

This application claims priority to and the benefit of U.S. Provisional Application No. 63/425,043, filed Nov. 14, 2022, the contents of which is incorporated into the present application by reference in its entirety.

### BACKGROUND OF THE INVENTION

### I. Field of the Disclosure

This disclosure generally concerns fertilizer compositions containing modified ingredients from waste products to produce soluble and slow release fertilizers. In particular embodiments, the disclosure concerns fertilizers containing soluble calcium (Ca), nitrogen (N) present as ammonium and nitrate, and sulfur(S) present as sulfate to provide a quick release fertilizer, with optional silicates to provide a slow release form. One or more source for production of the fertilizer can be waste products from industrial processes.

### II. Background

Soil nutrients, such as nitrogen, phosphorus, potassium, and sulfur, as well as trace elements such as iron, zinc, copper, calcium, and magnesium, are useful for achieving thriving agriculture and growth of plants. Upon repeated planting cycles, the quantity of these nutrients in the soil may be depleted, resulting in inhibited plant growth and decreased production. To counter this effect, fertilizers have been developed to help replace the depleted vital nutrients. Single-nutrient fertilizers and multi-nutrient fertilizers, such as fertilizer blends, have been developed to meet the varied needs of crop production worldwide.

Application of a fertilizer does not always provide the full amount of the nutrients in the fertilizer to the plant within a short period of time. Some fertilizers contain nutrient containing compounds that are not readily available to the plant upon application. In these circumstances, some apply fertilizer well before the planting of plants, or some over fertilize closer to the planting of the plants to provide sufficient nutrients to the plant initially. However, this comes at the cost of time, may require multiple treatments to the soil before or after planting, and/or may increase expenses.

Plants, such as crop plants, need nutrients at least over the entire growth and maturation period for the plant. However, many fertilizers, when applied to a soil, disperse, are degraded, or are taken up within a short period of time after application. To address this issue, fertilizers can be applied multiple times to the same plants or slow release fertilizers can be used.

Some approaches to applying fertilizers multiple times include dissolving fertilizers in water used to water the plants and delivering through the irrigation system. However, agricultural water can have temperatures and pH that vary greatly and can have dissolved ions that cause some added fertilizers to not dissolve or to precipitate out of solution.

Some approaches to slow release fertilizers include polymer coating a fertilizer core. However, many polymer coatings are expensive and/or will undesirably build up in the soil over time after repeated applications. Other approaches include coating or mixing with insoluble metal oxides, such as MgO and CaO. However, these metal oxides do not provide much, if any, nutrients to the plant.

Some approaches attempt to use industrial waste products as fertilizers that can have mixtures of immediate release nutrients (such as water soluble nutrients) and slow release nutrients (such as insoluble nutrients) that provide a variety of plant nutrients such as phosphorous and calcium. These products also can possibly reduce the costs compared to purer sources of nutrients and reduce the environmental impact of industrial waste. However, industrial waste products often contain chemicals that have very little use as nutrients for plants or may be damaging to plants, do not provide a variety of plant nutrients in ratios needed for soils and plants, and/or do not provide plant nutrients in ratios of immediate release to long term release forms needed for soil and plants.

### SUMMARY OF THE INVENTION

A solution to at least some of the problems discussed above is disclosed herein, including generating a fertilizer product without requiring urea, though urea may also be used in addition, that uses industrial waste products to produce a fertilizer product that provides a wide variety of soluble plant nutrients and that can also optionally include components to slow the release of some of the plant nutrients. Thus, the fertilizer can provide immediate release nutrients that can be used as a dry fertilizer and/or in water irrigation and/or can provide a combination of immediate and slow release nutrients in a single application. In some aspects, the fertilizer provides soluble calcium (Ca), nitrogen (N) present as ammonium and nitrate, and sulfur(S) present as sulfate to provide a quick release fertilizer, with optional silicates to bind the soluble nutrients to provide a slow release form. In some aspects, the fertilizer contains ammonium sulfate, calcium nitrate, and optionally ammonium silicate and/or silica as a binder. In some aspects, the fertilizer further contains one or more of water soluble magnesium nitrate, iron nitrate, aluminum nitrate, and manganese nitrate. In some instances, phosphorous may exist in the fertilizer as phosphoric acid and/or phosphate salts, such as calcium phosphate, magnesium phosphate, iron phosphate, aluminum phosphate, and/or manganese phosphate. In some instances, the fertilizer is produced by reacting nitric acid with one or more of: slag from production of metal, and waste gypsum (calcium sulfate) such as from production of phosphoric acid or extraction of titanium oxide. The fertilizer, in some instances, may be further modified by reaction with an ammonium source. Silicates can remain in the production process or be removed, such as after the reaction with nitric acid and/or after the reaction with the ammonia source.

In some embodiments, synthesis of at least part of the fertilizer occurs through reacting a slag with nitric acid to form at least calcium nitrate and a silicate and/or silica. In some embodiments, the silicate compounds and/or silica in the reaction product can be removed and dried. In some embodiments, the silicate compounds and/or silica in the reaction product can remain for further processing as outlined herein. Non-limiting example reactions that can occur include the following:

CaSiO₃+2HNO₃→Ca(NO₃)₂+H₂SiO₃

CaO+2HNO₃→Ca(NO₃)₂+2H₂O

MgO+2HNO₃→Mg(NO₃)₂+2H₂O

FeO+2HNO₃→Fe(NO₃)₂+2H₂O

MnO+2HNO₃→Mn(NO₃)₂+2H₂O

Al₂O₃+6HNO₃→2Al(NO₃)₃+3H₂O

In some embodiments, synthesis of at least part of the fertilizer occurs through reacting a calcium sulfate with nitric acid to form calcium nitrate and sulfuric acid, either in the same vessel as the reaction of slag with nitric acid or in a separate vessel or a separate time. Non-limiting example reactions can include the following:

CaSO₄+2HNO₃→Ca(NO₃)₂+H₂SO₄

In some embodiments, synthesis of at least part of the fertilizer occurs to form ammonium silicate through reacting an ammonium source with the product of the reaction of slag with nitric acid. The ammonia source can be, but is not limited to, ammonium hydroxide (NH₄OH) and/or ammonia gas, to produce ammonium nitrate. In some instances, the silicate compounds and/or silica is removed from the product of the reaction of slag with nitric acid before reacting with the ammonium source. In some instances, the silicate compounds and/or silica are not removed before reacting with the ammonium source. In some instances, silicate compounds and/or silica are removed after the reaction with the ammonium source. In some instances, silicate compounds and/or silica are not removed after the reaction with the ammonium source. Non-limiting example reactions can include the following:

H₂SiO₃+2NH₃→(NH₄)₂SiO₃

In some embodiments, synthesis of at least part of the fertilizer occurs through reacting the sulfuric acid with a source of ammonia to form ammonium sulfate, either in the same vessel as the reaction of an ammonium source with the product of the reaction of slag with nitric acid or in a separate vessel or at a separate time. Non-limiting example reactions can include the following:

H₂SO₄+2NH₃→(NH₄)₂SO₄

The final product may contain a mixture of the above composition chemicals, including, but not limited to any one or more of calcium nitrate, magnesium nitrate, iron nitrate, manganese nitrate, aluminum nitrate, silicate, hydrogen silicate, metasilicic acid, ammonium silicate, sulfuric acid, ammonium sulfate, calcium silicate, calcium oxide, magnesium oxide, iron oxide, manganese oxide, and/or aluminum oxide. In some instances, the slag used to produce the fertilizer contains phosphorous compounds and phosphorous may exist in the final product as phosphoric acid and/or phosphate salts, such as calcium phosphate, magnesium phosphate, iron phosphate, aluminum phosphate, and/or manganese phosphate.

In some aspects, the reactions are performed in one or more than one container. In some aspects, the reactions are performed simultaneously or sequentially or a mixture of both.

Embodiments of the disclosure are improvements to known fertilizers, including by involving the use of waste products to produce an immediate release fertilizer and/or soluble fertilizer comprising calcium (Ca), nitrogen (N) present as ammonium and nitrate, and sulfur(S) present as sulfate, and optionally one or more of magnesium (Mg), iron (Fe), manganese (Mn), and aluminum (Al). Embodiments of the disclosure can also provide improvements to known fertilizers, including by involving the use of waste products to produce a slow-release agent in a fertilizer comprising nitrogen (N) and silicon (Si). Current slow-release fertilizer products often use physical intervention to slow the release of the fertilizer, such as by coating the fertilizer with a polymer insoluble material to slow the fertilizer's release. Current slow-release fertilizers may also employ enzymatic inhibitors, such as urease inhibitors or nitrification inhibitors, to slow the utilization of the fertilizer. Though the fertilizers described herein may also contain physical interventions and/or inhibitors, the fertilizers described herein do not always require such measures to produce a slow-release nutrient fertilizer composition, as the silicate compounds or silica can be used to physically entrap soluble nutrients to prevent immediate release when exposed to water.

Embodiments herein describe mixtures of nutrients, and the preparation of such mixtures, which play a role for generating a quick release and or soluble fertilizer or a slow release fertilizer in soil as a reservoir of nutrients for release over time. The fertilizer can include an immediate-release aspect of the fertilizer that can comprise or consist of soluble reactants or products of the reactions described herein and any combination thereof, such as calcium nitrate, magnesium nitrate, iron nitrate, aluminum nitrate, manganese nitrate, and/or ammonium sulfate. The slow-release aspect of the fertilizer can comprise or consist of one or more silicate compound or silica, such as ammonium silicate.

In some aspects, the fertilizer comprises or consists of calcium nitrate and ammonium sulfate. In some aspects the fertilizer comprises or consists of ammonium silicate, calcium nitrate, and ammonium sulfate. In some aspects the fertilizer comprises or consists of silicate, calcium nitrate, and ammonium sulfate. In some aspects the fertilizer comprises or consists of ammonium silicate, silica, calcium nitrate, and ammonium sulfate. In some aspects the fertilizer further comprises or further consists of one or more of magnesium nitrate, iron nitrate, manganese nitrate, aluminum nitrate, sulfuric acid, hydrogen silicate, and metasilicic acid.

Fertilizers encompassed in certain embodiments herein comprise ingredients that can be used to cover immediate soil calcium, nitrogen, and sulfur, and optionally one or more of magnesium, iron, manganese, and aluminum deficiency in the form of an easily soluble calcium nitrate, magnesium nitrate, iron nitrate, aluminum nitrate, manganese nitrate, and/or ammonium sulfate, while also covering long-term silicon, calcium, nitrogen, and sulfur needs, and optionally one or more of magnesium, iron, manganese, and aluminum needs through a slow release controlled by one or more of ammonium silicate, silicate, hydrogen silicate, or metasilicic acid, and entrapment of soluble nutrients that provide calcium, nitrogen, and sulfur, and optionally one or more of magnesium, iron, manganese, and aluminum in the form of calcium nitrate, magnesium nitrate, iron nitrate, aluminum nitrate, manganese nitrate, and/or ammonium sulfate.

Certain aspects are directed to a fertilizer comprising a homogenous mixture comprising immediate-release agents as a soluble nitrogen source, a sulfur source, and a calcium source and optionally one or more of magnesium, iron, manganese, and aluminum source. The immediate-release agents may comprise calcium nitrate, magnesium nitrate, iron nitrate, aluminum nitrate, manganese nitrate, and/or ammonium sulfate. The homogenous mixture, in some aspects, does not comprise a binder. The homogenous mixture, in some aspects, comprises a binder. The binder can comprise a slow-release agent. The slow-release agent can comprise ammonium silicate, silicate, hydrogen silicate, and/or metasilicic acid.

Certain aspects are directed to a fertilizer comprising at least a portion of the immediate-release agents encapsulated by the silicate compounds or silica. Certain aspects are directed to a fertilizer comprising at least a portion of the immediate-release agents contained on the surface of the silicate compounds or silica. Certain aspects are directed to a fertilizer comprising at least a portion of the immediate-release agents contained in a dried gel of silicate compounds or silica.

In some aspects, the fertilizer does not comprise a binding agent separate from a silicate, such as ammonium silicate, silicate, hydrogen silicate, and/or metasilicic acid. The fertilizer can be a granular fertilizer.

In certain aspects, the fertilizer contains at least any one of, at most any one of, equal to any one of, or between any two of 15, 16, 17, 18, 19, 20, 21, 22, 23, 24, and 25 wt. % nitrogen (N), at least any one of, at most any one of, equal to any one of, or between any two of 5, 6, 7, 8, 9, 10, 11, 12, 13, 14, 15, 16, and 17 wt. % sulfur(S), and/or 7, 8, 9, 10, 11, 12, 13, 14, 15, 16, 17, 18, 19, and 20 wt. % calcium (Ca). In some instances, the immediate-release agent and the slow-release agent are comprised at a weight ratio between approximately 5:1 to 1:5, such as 5:1, 4:1, 3:1, 2:1, 1;1, 1:2, 1:3, 1:4, or 1:5.

In certain aspects, the fertilizer does not contain urea and/or a polymer. In certain aspects, the fertilizer further comprises urea and/or a polymer. In certain aspects, the fertilizer does not contain ammonium nitrate. In certain aspects, the fertilizer does not contain phosphorous and/or potassium.

In certain aspects, the calcium sulfate is gypsum. In certain aspects, the gypsum is and/or is sourced from or is comprised in red gypsum or waste gypsum or produced from production of phosphoric acid. A slag can be a byproduct from production of a metal. In some instances, a slag may contain silica and/or silicates and calcium, such as calcium oxide and/or calcium silicate, among other metal oxides. The other metal oxides can include, but are not limited to iron, magnesium, aluminum, and manganese. In some instances, slag contains phosphorous compounds, such as phosphoric acid. In certain aspects, the slag is slag from the production of steel, stainless steel, alloy steel, carbon steel, and/or phosphate.

Certain aspects are directed to a method of making a fertilizer, including any fertilizer described herein. The method can include steps (a) and/or (b). In step (a), a calcium sulfate and a slag are reacted with nitric acid to generate a first reaction product comprising at least a calcium nitrate, sulfuric acid, and optionally a silicate or silica. In some instances, step (a) comprises contacting the calcium sulfate and slag with nitric acid to generate the first reaction product comprising at least calcium nitrate, sulfuric acid, and optionally a silicate or silica. In some instances, step (a) does not react the calcium sulfate with nitric acid and the slag with nitric acid together, but instead reacts nitric acid and calcium sulfate separately from the reaction of slag with nitric acid. The products of these two separate reactions may then be combined to form the first reaction product. The products of these two separate reactions may remain separate as they are reacted in step (b). In some instances, some or all of the insoluble components of the first reaction product are removed, such as silicates or silica, before the reactions in step (b). In some instances, insoluble components of the first reaction product are not removed before the reactions in step (b). In some instances, the first reaction product is dried and used as a fertilizer with or without a silicate and/or silica. In some instances, some or all of the insoluble components of the first reaction product are removed, such as silicates or silica, and dried.

In step (b), the first reaction product, with or without a silicate and/or silica, can be contacted with a source of ammonia to generate a second reaction product comprising at least ammonium sulfate and unreacted products from the first reaction product, and optionally ammonium silicate. In some instances, step (b) comprises contacting the first reaction product that contains, in part, sulfuric acid and the optional silicate and/or silica with a source of ammonia to generate the second reaction product comprising an ammonium sulfate and ammonium silicate. In some instances, step (b) comprises contacting the first reaction product that does not contain a silicate or a silica with a source of ammonia to generate the second reaction product comprising ammonium sulfate. In some instances, step (b) comprises separately reacting with the ammonium source the product of reacting nitric acid with calcium sulfate and the product of reacting slag with nitric acid. The products of these two separate reactions may then be combined to form the second reaction product. In some instances, the products of these two separate reactions may remain separate. In some instances, some or all of the insoluble components of the second reaction product are removed, such as ammonia silicate or silica. In some instances, insoluble components of the second reaction product are not removed. In some instances, the second reaction product is dried and used as a fertilizer with or without a silicate and/or silica. In some instances, some or all of the insoluble components of the second reaction product are removed, such as ammonia silicate or silica, and dried.

In certain aspects, the method of making the fertilizer further comprises drying the fertilizer mixture, such as the first reaction product and/or the second reaction product to form a solid fertilizer composition. Steps (a) and (b) and/or drying may occur at approximately 30 °C to 150 °C, such as 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, and 150 °C. In some aspects, steps (a) and/or (b) may occur at 30 to 75 °C or any temperature or range therein. In some aspects, the fertilizer composition comprises or consists of any one or combination of: calcium nitrate, magnesium nitrate, iron nitrate, manganese nitrate, aluminum nitrate, silicate, hydrogen silicate, metasilicic acid, ammonium silicate, sulfuric acid, ammonium sulfate, calcium silicate, calcium oxide, magnesium oxide, iron oxide, manganese oxide, and/or aluminum oxide. In some aspects, the ammonia source comprises a solution of ammonium hydroxide, ammonium, ammonium carbonate, ammonia gas, succinimide, and/or phthalimide. In some instances, the slag used to produce the fertilizer contains phosphorous compounds and phosphorous may exist in the fertilizer as phosphoric acid and/or phosphate salts, such as calcium phosphate, magnesium phosphate, iron phosphate, aluminum phosphate, and/or manganese phosphate.

Also disclosed are the following aspects 1 to 20 of the present invention.

Aspect 1 is a fertilizer composition comprising ammonium sulfate, calcium nitrate, and ammonium silicate.

Aspect 2 is the fertilizer composition of aspect 1, wherein the composition comprises 17 to 22 wt. % nitrogen (N), 12 to 17 wt. % calcium (Ca), and 7 to 12 wt. % sulfur(S).

Aspect 3 is the fertilizer composition of any one of aspects 1 and 2, wherein the composition further comprises magnesium nitrate, iron nitrate, aluminum nitrate, manganese nitrate, and/or silica.

Aspect 4 is the fertilizer composition of any one of aspects 1 to 3, wherein the composition further comprises calcium sulfate, nitric acid, sulfuric acid, and/or ammonia.

Aspect 5 is the fertilizer composition of aspect 4, wherein the composition comprises calcium sulfate comprised in waste gypsum and/or a recycled gypsum.

Aspect 6 is the fertilizer composition of any one of aspects 1 to 5, wherein the composition does not comprise a binding agent separate from ammonium silicate or silica.

Aspect 7 is the fertilizer composition of any one of aspects 1 to 6, wherein at least a portion of the ammonium sulfate and/or calcium nitrate is absorbed on the surface of the ammonium silicate.

Aspect 8 is the fertilizer composition of any one of aspects 1 to 7, wherein the fertilizer composition further comprises a phosphorous source and/or potassium source.

Aspect 9 is the fertilizer composition of any one of aspects 1 to 8, wherein the fertilizer is homogenous.

Aspect 10 is the fertilizer composition of any one of aspects 1 to 9, wherein the composition comprises a gel.

Aspect 11 is the fertilizer composition of any one of aspects 1 to 10, wherein the composition comprises a dried gel.

Aspect 12 is the fertilizer composition of any one of aspects 1 to 11, wherein at least a portion of the ammonium sulfate and/or calcium nitrate is encapsulated by the ammonium silicate.

Aspect 13 is the fertilizer composition of any one of aspects 1 to 12, wherein the fertilizer composition is a granular fertilizer.

Aspect 14 is the fertilizer composition of any one of aspects 1 to 13, wherein the composition does not comprise at least one of urea or a polymer.

Aspect 15 is a method of producing the fertilizer composition of any one of aspects 1 to 14, the method comprising the steps of:
(a) contacting calcium sulfate and a slag with nitric acid to generate a first reaction product comprising:
   calcium nitrate, sulfuric acid, and a silicate and/or silica; and
(b) contacting the first reaction product with a source of ammonia to generate a second reaction product comprising:
   ammonium sulfate and ammonium silicate,
      wherein the second reaction product further comprises calcium nitrate from the first reaction product.

Aspect 16 is the method of aspect 15, wherein step (a) comprises:
contacting calcium sulfate with nitric acid to generate a product comprising:
   calcium nitrate and sulfuric acid; and
contacting nitric acid with the slag to generate a product comprising:
   calcium nitrate and a silicate and/or silica, and/or
      step (b) comprises:
contacting the silicate and/or silica with a source of ammonia to generate a product comprising:
   ammonium silicate; and
contacting sulfuric acid with a source of ammonia to generate a product comprising: ammonium sulfate.

Aspect 17 is the method of any one of aspects 15 to 16, further comprising drying the second reaction product to form a solid fertilizer composition.

Aspect 18 is the method of any one of aspects 15 to 17, wherein the calcium sulfate comprises red gypsum and/or waste gypsum from production of phosphoric acid, wherein the source of ammonia is ammonium hydroxide and/or ammonia, and/or wherein the slag is slag from the production of a metal and/or phosphate, the metal being a steel such as steel, stainless steel, alloy steel, and/or carbon steel.

Aspect 19 is the method of any one of aspects 15 to 18, wherein steps (a) and/or (b) occurs at 30 to 150 °C and/or for 30 minutes to 12 hours.

Aspect 20 is a method of fertilizing, the method comprising contacting a plant, a soil, water, or a combination thereof with the fertilizer compositions of any one of aspects 1 to 14.

The term “fertilizer” is defined as a material applied to soils or to plant tissues to supply one or more plant nutrients essential or beneficial to the growth of plants and/or stimulants or enhancers to increase or enhance plant growth.

The term “granule” can include a solid material. A granule can have a variety of different shapes, non-limiting examples of which include a spherical, a puck, an oval, a rod, an oblong, or a random shape.

The term “particle” can include a solid material less than a millimeter in its largest dimension.

The terms “particulate” or “powder” can include a plurality of particles.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The use of the word “a” or “an” when used in conjunction with the term “comprising” may mean “one,” but it is also consistent with the meaning of “one or more,” “at least one,” and “one or more than one.”

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of”′ any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1: a schematic of a system and method for producing a fertilizer according to a non-limiting example of a system and method disclosed herein.

FIG. 2: a schematic of a system and method for producing a fertilizer according to another non-limiting example of a system and method disclosed herein.

### DETAILED DESCRIPTION OF THE INVENTION

Certain aspects of the present disclosure provide benefits over existing fertilizers, including without requiring urea, though urea may also be used in addition, the use of industrial waste products to produce a fertilizer product that provides a wide variety of soluble plant nutrients and that can also optionally include components to slow the release of some of the plant nutrients. The fertilizer can provide immediate release nutrients that can be used as a dry fertilizer and/or in water irrigation and/or can provide a combination of immediate and slow release nutrients in a single application. This capability can be achieved, in some aspects, without the use of binders, inhibitors, or other interventions that add compounds beyond silicates and/or silica. Silicates and/or silica can remain in the product or be removed.

### I. Fertilizer

Certain embodiments herein concern a fertilizer comprising: ammonium sulfate, calcium nitrate, and optionally ammonium silicate and/or silica as a binder. Certain aspects involve synthesis of the fertilizer using waste products as sources of reactants to produce the ingredients of the fertilizer. Waste products that can be used as sources of reactants include, but are not limited to, waste gypsum, red gypsum, and/or a slag. In some aspects, the fertilizer is a mixture that is a homogeneous mixture. In some aspects, the ammonium silicate and/or silica entraps at least a portion of the other ingredients in the fertilizer to slow their release when exposed to water. In some aspects, the fertilizer is contacted with water to solubilize the fertilizer and then the solubilized fertilizer is applied to a plant and/or soil.

The fertilizer, which may be a fertilizer granule, can contain a mixture containing calcium (Ca), nitrogen (N) present as ammonium and/or nitrate, and sulfur(S) present as sulfate. The ratio of elements present in the fertilizer may be tailored to specific applications. In some instances, the fertilizer further comprises one or more of magnesium, iron, aluminum, and manganese.

At least a portion of Ca can be present as calcium nitrate. In some aspects, at least 90 wt. %, or at least 95 wt. %, or 90 wt. % to 100 wt. %, or at least any one of, at most any one of, equal to any one of, or between any two of 90, 91, 92, 93, 94, 95, 96, 97, 98, 99, 99.5, and 100 wt. % of the Ca in the mixture can be present as calcium nitrate, based on the total weight of Ca in the mixture. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Ca in the mixture can be present as calcium nitrate.

In some aspects, the fertilizer can contain i) calcium nitrate in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % based on the total weight of the mixture and/or the fertilizer granule, ii) ammonium sulfate in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 wt. % based on the total weight of the mixture and/or the fertilizer granule, optionally iii) ammonium silicate in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 wt. % based on the total weight of the mixture and/or the fertilizer granule, and optionally iv) silicate in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 wt. % based on the total weight of the mixture and/or the fertilizer granule. In some aspects, the fertilizer further comprises one or more of magnesium nitrate, iron nitrate, aluminum nitrate, and manganese nitrate.

In some aspects, the homogenous mixture comprises Ca, N, and/or S wherein i) the Ca content of the homogenous mixture can be at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. %, ii) the N content of the homogenous mixture can be at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. %, iii) the S content of the homogenous mixture can be at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. %, based on the total weight of the mixture and/or fertilizer.

The Ca, N, and/or S can be present as and/or sourced as a water soluble compound or a water insoluble compound. In some instances, the Ca, N, and/or S can be present as a salt. In some aspects, the Ca, N, and/or S can be present as a water soluble salt. In some instances, the water soluble Ca, N, and/or S salt can be ammonium sulfate and/or calcium nitrate. In some aspects, the fertilizer further contains one or more of water soluble salts magnesium nitrate, iron nitrate, aluminum nitrate, and manganese nitrate. The salt can be in a non-hydrate and/or one or more hydrate form.

In certain aspects, the calcium sulfate is gypsum. In certain aspects, the gypsum is and/or is sourced from or is comprised in red gypsum or waste gypsum, such as gypsum from production of phosphoric acid. In certain aspects, the products are produced in part from slag. The slag may be, but is not limited to slag from the production of steel, stainless steel, alloy steel, carbon steel, and/or phosphate.

Moisture content of the dried fertilizer can be less than 1 wt. %, such as 0.1 wt. % to 0.9 wt. %, or any one of or between any two of 0.1, 0.2, 0.3, 0.4, 0.5, 0.6, 0.7, 0.8, 0.9, or 1 wt. %, or any range thereof, based on the weight of the fertilizer granule. As a non-limiting example, the moisture content can be measured by drying the sample at 50 °C for 25 min and measuring the amount of mass lost by the fertilizer after being dried.

The fertilizer can be of any suitable shape. Non-limiting shapes include spherical, cuboidal, cylindrical, puck shape, oval, and oblong shapes. In some aspects, the fertilizer granule can be of cylindrical shape with a circular, elliptical, ovular, triangular, square, rectangular, pentagonal, or hexagonal cross section, although cylindrical shaped core having a cross-section of other shapes can also be made. In some aspects, the fertilizer granule at its widest dimension can be 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm. In some particular aspects, the fertilizer granule can have a substantially spherical shape with an average diameter 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm.

The fertilizer can be water and/or soil dispersible. In some aspects, a fertilizer granule having a size of 2 mm to 4 mm prior to adding to water, can disintegrate into particles having sizes less than 1 mm, less than 0.9 mm, less than 0.8 mm, less than 0.7 mm, less than 0.6 mm, less than 0.5 mm, less than 0.4 mm, or less than 0.3 mm, within 1 minute of adding the granule to water at a pH 7, under stirring at a rate 90 rpm to 110 rpm, at an ambient temperature.

The mixture can have a compositional make-up that is substantially homogeneous. In some instances, a compositional make-up for a 1 mm×1 mm×1 mm cube at any position of the mixture can be similar (within ±20%, or ±10%, or ±5%, or ±3%, ±2%, or ±1%, or ±0.5%) to that of a 1 mm×1 mm×1 mm cube at any other position of the mixture.

In some aspects, the fertilizer granule can contain an homogeneous mixture. The homogeneous mixture can have compositions as described above. In some instances, the homogenous mixture can have an optional coating on the outer surface of the homogenous mixture. In some instances, the ammonium silicate and/or silica can act as a binder in the fertilizer. In some instances the ammonium silicate and/or silica is the only binder in the fertilizer. In some instances, the ammonium silicate and/or silica forms an amorphous phase, a continuous phase, and/or encapsulates other ingredients in the fertilizer. In some instances, the fertilizer comprises a matrix of ammonium silicate and/or silica that at least partially surrounds and/or encapsulates at least a portion of the ammonium sulfate and/or calcium nitrate and/or other soluble components of the fertilizer. In some instances, the fertilizer comprises particles of the ammonium silicate, silica, calcium nitrate, and/or of ammonium sulfate.

In some aspects, additional fertilizer substances can be included or excluded in the fertilizer. If included, additional fertilizers can be chosen based on the particular needs of certain types of soil, climate, or other growing conditions to maximize the efficacy of the fertilizer in enhancing plant growth and crop yield. Additional additives may also be included or excluded in the fertilizer. Non-limiting examples of additives that can be included or excluded from the fertilizer of the present invention include additional nitrogen nutrients, phosphorus nutrients, potassium nutrients, additional micronutrients, and/or additional secondary nutrients. The micronutrient can be copper, iron, chloride, manganese, molybdenum, or nickel, or any combinations thereof. The nitrogen nutrient can be urea, ammonium nitrate, ammonium sulfate, diammonium phosphate, monoammonium phosphate, urea-formaldehyde, ammonium chloride, or potassium nitrate, or any combination thereof. In some aspects, the additional secondary nutrients may include lime and/or superphosphate. In some instances, the additional fertilizer substances and/or the additional additives are contained in the optional coating of the fertilizer.

In some instances, the inhibitors include nitrification inhibitors and/or urease inhibitors. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. In one aspect, a nitrification inhibitor can comprise DMPP, DCD, TU, nitrapyrin, 5-ethoxy-3-trichloromethyl-1,2,4-thiadiazol, AM, MBT, or ST, or a combination thereof. In some embodiments, a fertilizer composition can comprise NBTPT, DMPP, TU, DCD, PPDA, nitrapyrin, 5-ethoxy-3-trichloromethyl-1,2,4-thiadiazol, AM, MBT, ST, or a combination thereof.

In some instances, a binder includes a phosphate, a polyphosphate, a biodegradable polymer, or a wax, or a combination thereof. Suitable waxes include, but are not limited to, vegetable waxes, high melt waxes, ethylene bis(stearamide) wax, paraffin waxes, polyethylene based waxes, and olefin waxes. Suitable phosphates include, but are not limited to, diammonium phosphate, and monoammonium phosphate. Suitable polyphosphates include, but are not limited to, ammonium polyphosphate. Suitable biodegradable polymers include, but are not limited to, polyacrylamide, polyacrylic acid, polyacrylonitrile, biodegradable polylactic acid and other biodegradable polymeric material such as polylactic acid, poly(3-hydroxypropionic acid), polyvinyl alcohol, poly e-caprolactone, poly L-lactide, poly butylene succinate, and biodegradable starch based polymers. The binder can include plaster of Paris, flour, starch, gluten, kaolin, bentonite, colloidal silica, or combinations thereof. Suitable flours include, but are not limited to, rice flour, wheat flour, and bleached wheat flour. Suitable starches include, but are not limited to, dextrin modified starches.

In some instances, the pH buffers include MgO, KH₂PO₄, NaHCO₃, chalk powder, aluminum, magnesium hydroxide, aluminum hydroxide/magnesium hydroxide co-precipitate, aluminum hydroxide/sodium bicarbonate co-precipitate, calcium acetate, calcium bicarbonate, calcium borate, calcium carbonate, calcium bicarbonate, calcium citrate, calcium gluconate, calcium hydroxide, dibasic sodium phosphate, dipotassium hydrogen phosphate, dipotassium phosphate, disodium hydrogen phosphate, magnesium acetate, magnesium borate, magnesium bicarbonate, magnesium carbonate, magnesium hydroxide, magnesium lactate, magnesium oxide, magnesium phosphate, magnesium silicate, magnesium succinate, magnesium tartrate, potassium acetate, potassium carbonate, potassium bicarbonate, potassium borate, potassium citrate, potassium metaphosphate, potassium phthalate, potassium phosphate, potassium polyphosphate, potassium pyrophosphate, potassium succinate, potassium tartrate, sodium acetate, sodium bicarbonate, sodium borate, sodium carbonate, sodium citrate, sodium gluconate, sodium hydrogen phosphate, sodium hydroxide, sodium lactate, sodium phthalate, sodium phosphate, sodium polyphosphate, sodium pyrophosphate, sodium tartrate, sodium tripolyphosphate, synthetic hydrotalcite, tetrapotassium pyrophosphate, tetrasodium pyrophosphate, tripotassium phosphate, trisodium phosphate, and trometamol, and combinations thereof.

The fertilizer described herein can be comprised in a composition useful for application to soil. In some aspects, in addition to the fertilizer described herein, the composition may include other fertilizer compounds, micronutrients, primary nutrients, urea, additional nitrogen nutrients, insecticides, herbicides, or fungicides, or combinations thereof. The fertilizer described herein can also be included in a blended composition comprising other fertilizers. The other fertilizer can be urea, monoammonium phosphate (MAP), diammonium phosphate (DAP), muriate of potash (MOP), monopotassium phosphate (MKP), triple super phosphate (TSP), rock phosphate, single super phosphate (SSP), ammonium sulfate, and the like.

A fertilizer formed into a granule can have desirable physical properties such as desired levels of abrasion resistance, granule strength, pelletizability, hygroscopicity, granule shape, and size distribution. In some aspects, The fertilizer granule can have a crush strength above 1.5 kgf, such as above 1.8 kgf, such as 2 kgf to 6 kgf, or at least any one of, equal to any one of, or between any two of 2, 2.5, 3, 3.5, 4, 4.5, 5, 5.5, and 6 kgf. Bulk density of the fertilizer granules can be 1 g/cc to 1.2 g/cc, or at least any one of, at most any one of, equal to any one of, or between any two of 1, 1.02, 1.04, 1.06, 1.08, 1.1, 1.12, 1.14, 1.16, 1.18, and 1.2 g/cc. In some aspects, 10 mg or more, such as 10 mg to 40 mg, or at least any one of, at most any one of, equal to any one of, or between any two of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 mg of the fertilizer granule can dissolve in 1 ml of water at a pH 7, under stirring at a rate 90 to 110 rpm, and at an ambient temperature, within 5 minutes of adding 100 mg of the fertilizer granules to the water. In some aspects, the fertilizer granule is capable of losing less than 0.13 wt. %, such as 0.02% to 0.12 wt. %, or at most any one of, equal to any one of, or between any two of 0.02, 0.03, 0.04, 0.05, 0.06, 0.07, 0.08, 0.09, 0.1, 0.11, and 0.12 wt. % in an attrition loss test. Attrition loss can be measured using the following attrition loss test.

Attrition loss test: A plurality of sieved fertilizer granules with individual size 2 to 4 mm, and total volume 100 cm³ is weighed (W1) and is placed into the test drum along with the 50 stainless steel balls having a total weight of 100 μm. The drum is closed and rotated for 10 min at 30 rpm. Then, the steel balls are separated from the sample and the material is screened over 2 mm sieve using a sieve shaker. The total weight of the granules over 2 mm are then re-weighed (W2). Results are calculated in terms of % weight loss using the formula:

$$Weight loss due to attrition ( wt . \% ) = \frac{weight of sample remained on 2 mm sieve ( ( W 2 ) )}{intial weight of the sample ( W 1 )} \times 100$$

### II. Method of Making a Fertilizer

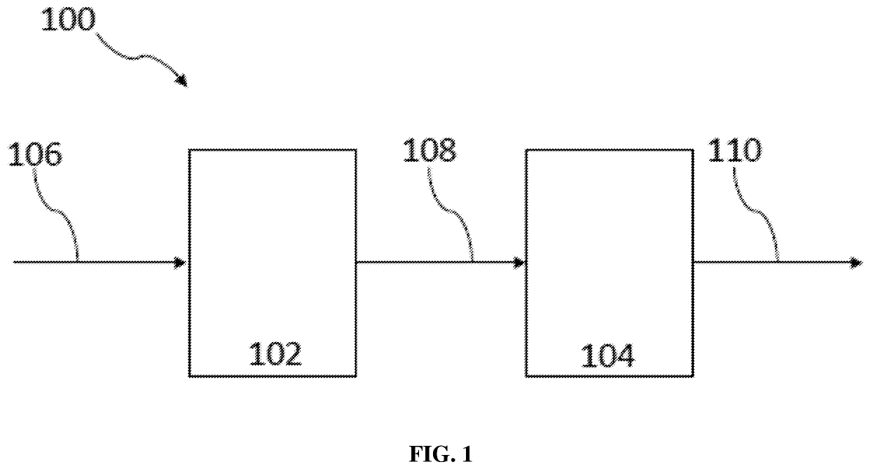

Referring to FIG. 1, a schematic of a system and method for making a fertilizer according to one example of the present invention is described. The system 100 can include a granulator 102 and a dryer 104. A feed mixture 106 can be granulated in the granulator 102 in the presence or absence of water to form a wet granulated mixture 108. The water, if present, can be provided with the feed mixture 106, and/or can be added separately to the granulator 102. The wet granulated mixture 108 can be dried in the dryer 104 to obtain dry granulated mixture 110 containing the fertilizer.

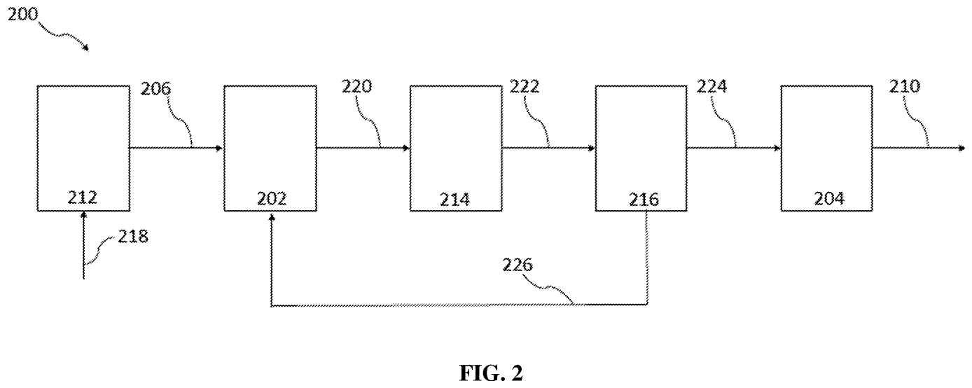

Referring to FIG. 2, a schematic of a system and method for making a fertilizer according to another example of the present invention is described. The system 200 can include a mixer/reactor 212, though the mixer and the reactor can be two, three, four, or more components, such as two reactors and a mixer or a reactor and a mixer. The system 200 can include a granulator 202, a spheronizer 214, one or more size screens 216, and a dryer 204, or any combination thereof. The feed mixture ingredients 218, separately and/or at any possible combination can be added to the mixer/reactor 212. In the mixer/reactor 212, the feed ingredients can be reacted and/or mixed to form the feed mixture 206. Feed mixture 206 can be granulated in the granulator 202 in presence or absence of additional water to form a wet granulated mixture 220. Granules of the wet granulated mixture 220 can be spheronized in the spheronizer 214 to form a wet granulated mixture 222 containing substantially spherical granules. The wet granulated mixture 222 can be passed through one or more size screens 216 to separate granules having a size smaller or bigger than a desired size from the wet granulated mixture 222 and obtain a wet granulated mixture 224 containing granules of desired size. At least a portion of the granules separated 226 from the granulation mixture 224 containing granules of desired size can be recycled to the granulator 202. The wet granulated mixture 224 containing granules of desired size can be dried in the dryer 204 to obtain dry granulated mixture 210 containing the fertilizer granule. In some aspects, the mixer/reactor 212 can contain a ribbon mixer.

The feed mixture ingredients 218 can include i) a Ca source, e.g., slag, calcium sulphate, calcium silicate, calcium oxide, ii) a N source, e.g., nitric acid, NH₄⁺, NH₄OH, and/or NH₃, iii) a S source, e.g., calcium sulphate. In some instances, a mixture ingredient provides more than one of Ca, N, and/or S. In some instances, a mixture ingredient provides additional nutrients and/or micronutrients, such as P, K, Mg, Fe, Mn, Al, and/or Si, such as magnesium oxide, iron oxide, manganese oxide, aluminum oxide, calcium phosphate, magnesium phosphate, iron phosphate, aluminum phosphate, manganese phosphate, and/or phosphoric acid. In certain aspects, one or more ingredients can be added as a water solution. In some instances, the mixture ingredients are provided as a powder. In some instances, one or more ingredients can be added as a gas. In some instances, the NH₃ is provided at a pressure above 1 bar, such as at, or between, or of any range of 1.2, 1.3, 1.4, 1.5, 2, 2.5, 3, 3.5, 4, 4.5, 5, 5.5., 6, 6.5, 7, 7.5, 8, 9, 10, 15, 20, 25, 30, 35, and 40 bar. In some instances, a portion of the mixture of ingredients is provided as a powder.

The feed mixture 106, 206 can contain Ca, N, and/or S. In some aspects, the feed mixture 106, 206 can contain calcium nitrate, magnesium nitrate, iron nitrate, manganese nitrate, aluminum nitrate, silicate, hydrogen silicate, metasilicic acid, ammonium silicate, sulfuric acid, ammonium sulfate, calcium silicate, calcium oxide, magnesium oxide, iron oxide, manganese oxide, and/or aluminum oxide. In some instances the feed mixture 106, 206 can contain calcium phosphate, magnesium phosphate, iron phosphate, aluminum phosphate, manganese phosphate, and/or phosphoric acid.

Water can be added to the feed mixture in the mixer/reactor 212 and/or in the granulator 102, 202. In certain aspects, 5 μm to 20 μm, or at least any one of, at most any one of, equal to any one of, or between any two 5, 6, 7, 8, 9, 10, 11, 12, 13, 14, 15, 16, 17, 18, 19, and 20 μm of water in total (e.g., added with one or more feed mixture ingredients and/or separately) can be added to the feed mixture, per 100 μm of feed mixture.

In some aspects, the granulator 102, 202 can be a drum granulator, pugmill granulator, pan granulator, solid mixer, abrasion drum, extruder, high-shear mixer granulator, roller granulator, mycromix, or a round bottom flask. In the granulator 102, 202 the feed mixture 106, 206 can be granulated by agglomeration, spray granulation, compaction, slurry granulation and/or high-shear mixer granulation. In some particular aspect, the feed mixture 106, 206 can be granulated in the granulator 102, 202 by compaction. In some aspects, the granulator 102, 202 can contain at least two rollers and compaction granulation can include compressing the feed mixture using the at least two rollers. In some aspects, the two rollers can be moved in counter current direction during compaction. In some aspects, the feed mixture can be compressed into shaped pellets, such as cylindrical pellets, by the at least two rollers. In some aspects, a surface of one roller can have desired holes to compress the feed mixture into the holes, and the surface of the other roller can push the feed mixture into the holes. Pressure during granulation, e.g. compaction granulation can be 1 bar to 40 bar, or at least any one of, at most any one of, equal to any one of, or between any two 1, 2, 3, 4, 5, 10, 15, 20, 25, 30, 35, and 40 bar. In certain aspects, the feed mixture can be granulated in the granulator 102, 202 at ambient temperature to 50 °C, or at least any one of, at most any one of, equal to any one of, or between any two of −20, −15, −10, 0, 5, 10, 15, 20, 25, 30, 35, 40, 45 and 50° C.

In some aspects, reacting of the feed mixture ingredients, mixing, and granulating the feed mixture can be performed in different containers, e.g., the mixer/reactor 212 and the granulator 202 can be different containers. In some aspects, reacting of the feed mixture ingredients, mixing, and granulating the feed mixture can be performed in the same container, e.g., the mixer/reactor 212 and the granulator 202 can be the same container (not shown). In some aspects, the mixer/reactor 212 and the granulator 202 can be more than two containers. As non-limiting examples, in some instances, the ammonium silicate and ammonium sulfate are formed in two different containers. In some instances, the ammonium silicate and ammonium sulfate are formed in one container. In some instances, the silicate and/or silica and the sulfuric acid are formed in two different containers. In some instances, the silicate and/or silica and the sulfuric acid are formed in one container. In some instances, the silicate and/or silica and the sulfuric acid are formed in two different containers and the ammonium silicate and ammonium sulfate are formed in one container. In some instances, the silicate and/or silica, sulfuric acid, ammonium silicate, and ammonium sulfate are formed in one container. In some instances, the silicate and/or silica, sulfuric acid, ammonium silicate, and ammonium sulfate are each formed in different containers.

In some aspects, the silicate and/or silica, sulfuric acid, calcium nitrate, ammonium silicate, and ammonium sulfate are formed at a temperature of at least, at most, equal to, or between any two of 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150 °C, such as between 30 and 80 °C or between 100 and 150 °C or between 75 and 150 °C or between 55 to 75 °C or between 30 and 150 °C.

In some instances, the fertilizer can be extruded before drying. The extruder can extrude the fertilizer at pressures at least, at most, equal to, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 bar. The extruder can extrude the fertilizer at temperatures at least, at most, equal to, or between any two of −20,−15, −10, 0, 5, 10, 15, 20, 25, 30, 35, 40, 45 and 50 °C. The extrudate can be sliced or divided before drying, such as by a die.

In certain aspects, the desired size of a final fertilizer product, such as a granule, can be 0.5 to 5 mm, or 1 to 4 mm, and having a size lower than 0.5 mm or 1 mm, and/or having a size bigger than 4 mm or 5 mm can be separated from the wet granulated mixture 222 in the one or more size screens 216. In certain aspects, the wet granulated mixture can be rounded and/or spheronized in a spheronizer. In some instances, the wet granulated mixture is contacted with a spheronizer for at least any one of, at most any one of, equal to any one of, or between any two of 5, 10, 15, 20, 25, 30, 35, 40, 50, or 60 seconds. The spheronizer in some instances has a rotating or rotatable disk capable of rotating at least any one of, at most any one of, equal to any one of, or between any two of 200, 500, 1000, 1500, 2000, 2500, 3000, 3500, 4000, 4500, 5000 rpm. In certain aspects, the wet granulated mixture can be dried in the dryer 104, 204 at a temperature 40 °C to 150 °C, or at least any one of, at most any one of, equal to any one of, or between any two of 40, 45, 50, 55, 60, 65, 70, 75, 80, 85, 90, 95, 100, 105, 110, 115, 120, 125, 130, 135, 140, 145, 150 °C. In some aspects, the dryer 104, 204 can be a fluid bed dryer, drum dryer, or flash dryer. In some aspects, the wet granulated mixture can be dried in the dryer 104, 204 with an hot air flow having a flow rate of at least any one of, at most any one of, equal to any one of, or between any two of 100, 150, 200, 250, 300, 350, 400, 450, and 500 m³/hr and/or a rotation of at least any one of, at most any one of, equal to any one of, or between any two of 5, 10, 15, 20, 25, 30, 35, 40, 45, and 50 rpm.

### III. Methods of Using the Fertilizer

The fertilizer, including fertilizer granules, compositions containing the fertilizer, and fertilizer blends containing the fertilizer of the present disclosure can be used in methods of increasing the amount of one or more plant nutrients in soil and of enhancing plant growth. Such methods can include applying to the soil an effective amount of a composition and/or blend containing the fertilizer of the present invention. The method may include increasing the growth and yield of crops, trees, ornamentals, etc., such as, for example, palm, coconut, rice, wheat, corn, barley, oats, and/or soybeans. The method can include applying the fertilizer blend of the present invention to at least one of a soil, an organism, a liquid carrier, a liquid solvent, etc. The composition(s) and/or fertilizer blends(s) containing the fertilizer can be applied to plants and/or soil as a top dressing fertilizer, basal fertilizer, and/or through any suitable method of application.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes.

The effectiveness of compositions comprising the fertilizer of the present invention can be ascertained by measuring the amount of phosphorus and optionally other nutrients in the soil at various times after applying the fertilizer composition to the soil. It is understood that different soils have different characteristics, which can affect the stability of the nutrients in the soil. The effectiveness of a fertilizer composition can also be directly compared to other fertilizer compositions by doing a side-by-side comparison in the same soil under the same conditions.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Preparation of a Fertilizer

100 g of slag can be mixed with 166 g nitric acid at temperature 40 °C and stirred for 2 hours to form a gel. The metal oxides in the slag can react with the nitric acid and transform to nitrate salts of the metals. The gel can be cooled to room temperature and filtered to separate the filtrate from the silica gel. The separated filtrate and silica gel can be dried separately at 120 °C for 4 hours. The dried filtrate produced can comprise a mixed nitrate fertilizer. The amount of metal nitrates in the fertilizer produced can be 205 g, while the amount of separated silica gel produced can be 32 g.

### Example 2

### Preparation of a Fertilizer

A mixture of 50 g of calcium sulfate and 50 g of calcium silicate contained in slag can be added to a 200 ml solution of nitric acid (containing 94.6 g nitric acid). The mixture can be stirred for 2 hours at 40 °C. After 2 hours, a 30% solution of ammonium hydroxide providing the equivalent of 25.5 g ammonia can be added and reacted for 2 hours. The temperature can be increased to 60 °C to slowly evaporate water. The product can be dried in an oven at 120 °C for 4 hours to form a solid material. The solid material can be ground to particles to fit through a size 20-40 mesh.

The fertilizer produced can contain 133.5 g calcium nitrate, 48.5 g ammonium sulfate, and 48.2 g ammonium silicate. The fertilizer can contain 19.5% N, 4.5% Ca, and 12.9% S by weight.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

1. A fertilizer composition comprising ammonium sulfate, calcium nitrate, and ammonium silicate.

2. The fertilizer composition of claim 1, wherein the composition comprises 17 to 22 wt. % nitrogen (N), 12 to 17 wt. % calcium (Ca), and 7 to 12 wt. % sulfur(S).

3. The fertilizer composition of claim 1, wherein the composition further comprises magnesium nitrate, iron nitrate, aluminum nitrate, manganese nitrate, and/or silica.

4. The fertilizer composition of claim 1, wherein the composition further comprises calcium sulfate, nitric acid, sulfuric acid, and/or ammonia.

5. The fertilizer composition of claim 4, wherein the composition comprises calcium sulfate comprised in waste gypsum and/or a recycled gypsum and/or comprises slag from the production of a metal.

6. The fertilizer composition of claim 1, wherein the composition does not comprise a binding agent separate from ammonium silicate or silica.

7. The fertilizer composition of claim 1, wherein at least a portion of the ammonium sulfate and/or calcium nitrate is absorbed on the surface of the ammonium silicate.

8. The fertilizer composition of claim 1, wherein the fertilizer composition further comprises a phosphorous source and/or potassium source.

9. The fertilizer composition of claim 1, wherein the fertilizer is homogenous.

10. The fertilizer composition of claim 1, wherein the composition comprises a gel.

11. The fertilizer composition of claim 1, wherein the composition comprises a dried gel.

12. The fertilizer composition of claim 1, wherein at least a portion of the ammonium sulfate and/or calcium nitrate is encapsulated by the ammonium silicate.

13. The fertilizer composition of claim 1, wherein the fertilizer composition is a granular fertilizer.

14. The fertilizer composition of claim 1, wherein the composition does not comprise at least one of urea or a polymer.

15. A method of producing the fertilizer composition of claim 1, the method comprising the steps of:
(a) contacting calcium sulfate and a slag from the production of a metal with nitric acid to generate a first reaction product comprising:
calcium nitrate, sulfuric acid, and a silicate and/or silica; and
(b) contacting the first reaction product with a source of ammonia to generate a second reaction product comprising:
ammonium sulfate and ammonium silicate,
wherein the second reaction product further comprises calcium nitrate from the first reaction product.

16. The method of claim 15, wherein step (a) comprises:
contacting calcium sulfate with nitric acid to generate a product comprising: calcium nitrate and sulfuric acid; and
contacting nitric acid with the slag from the production of a metal to generate a product comprising:
calcium nitrate and a silicate and/or silica, and/or
step (b) comprises:
contacting the silicate and/or silica with a source of ammonia to generate a product comprising:
ammonium silicate; and
contacting sulfuric acid with a source of ammonia to generate a product comprising:
ammonium sulfate.

17. The method of claim 15, further comprising drying the second reaction product to form a solid fertilizer composition.

18. The method of claim 15, wherein the calcium sulfate comprises red gypsum and/or waste gypsum from production of phosphoric acid, wherein the source of ammonia is ammonium hydroxide and/or ammonia, and/or wherein the slag from the production of a metal is slag from the production of a steel.

19. The method of claim 15, wherein steps (a) and/or (b) occurs at 30 to 150 °C and/or for 30 minutes to 12 hours.

20. A method of fertilizing, the method comprising contacting a plant, a soil, water, or a combination thereof with the fertilizer composition of claim 1.
